(19) United States
(12) Patent Application Publication
(10) Pub. No.: US 2006/0200652 A1
(43) Pub. Date: Sep. 7, 2006

(54) Method for Signaling of a State or of an Event

(76) Inventors: Jens Barrenscheen, Munchen (DE); Hans Sulzer, Erding (DE)

Correspondence Address: BAKER BOTTS, L.L.P., 98 SAN JACINTO BLVD., SUITE 1500, AUSTIN, TX, 78701-4039, US

(21) Appl. No.: 11/276,427

(22) Filed: Feb. 28, 2006

(30) Foreign Application Priority Data
Mar. 1, 2005 (DE) 10 2005 009 874.6

(51) Int. Cl. G06F 15/00

(52) U.S. Cl. 712/220

(57) ABSTRACT

A first component is signaled from a second component by a status signal that a state or an event which requires a reaction has occurred. First data items are stored in the second component which can be set to a specific value by the second component and can be reset by the first component when a first state or event occurs. Second data items are stored in the second component which can be set to a specific value and can be reset when a second state or event occurs. The first and second data items and are subjected to a logic operation, and the result of the logic operation is used as the status signal which is transmitted to the first component. After each resetting, a different signal from the status signal is used for a predetermined time instead of the result of the logic operation.

### PRIORITY

This application claims priority from German Patent Application No. 10 2005 009 874.6, which was filed on Mar. 1, 2005, and is incorporated herein by reference in its entirety.

### TECHNICAL FIELD

This invention relates to a method for transmitting a status signal in an electrical circuit.

### BACKGROUND

The basic design of a microcontroller is illustrated in FIG. 1. The microcontroller 1 illustrated in FIG. 1 contains a CPU 11, an analog/digital converter 12, and a range of further components 13 to in, in which case these further devices may comprise, for example, a digital/analog converter, a compression device, a timer, one or more memory devices and/or any other desired devices which may be a component of a microcontroller. The stated components of the microcontroller, that is to say the CPU 11, the analog/digital converter 12 and the further components 13 to in, are connected to one another via a bus BUS. Individual components can additionally be connected via one or more additional lines. By way of example, in the example under consideration, the CPU 11 and the analog/digital converter 12 are connected to one another via an additional line IRQL.

The components of said microcontroller that are of particular interest in the present case are the CPU 11 and the analog/digital converter 12. The CPU 11 is the first component mentioned initially, and the analog/digital converter 12 is the second component mentioned initially.

One or more analog signals are supplied to the analog/digital converter 12 via the input connections (which are not shown in FIG. 1) of the microcontroller, and are converted to digital values by the analog/digital converter 12. These digital values are written to three result registers 121, 122, 123 which are contained in the analog/digital converter 12. The time at which the analog/digital converter 12 has to convert which analog signal, and the result register to which the conversion result must be written are predetermined for the analog/digital converter 12 by the CPU 11 or some other microcontroller component, or are set in the analog/digital converter 12.

Each of the result registers 121 to 123 contains a valid bit V which indicates whether a new digital value has been written to the respective result register since that particular result register was last read. This valid bid is set whenever a new value is written to the result register, and reset whenever the value which is stored in the result register has been read. To be more precise, the procedure is:
that the valid bit of the result register 121 is set after writing data to the result register 121, and is reset after the data items which have been stored in the result register 121 have been read,
that the valid bit of the result register 122 is set after data items have been written to the result register 122, and is reset after the data items which have been stored in the result register 122 have been read, and
that the valid bit of the result register 123 is set after data has been written to the result register 123, and is reset after the data which was stored in the result register 123 has been read.

The valid bit V is in each case set by the analog/digital converter 12 and it is reset by the component which reads the result register and which, in the example under consideration, is the CPU 11.

When a new value has been written to one or more of the result registers 121 to 123, the analog/digital converter 12 signals this state or this event to the CPU 11 by means of a status signal which is transmitted via the line IRQL.

When the CPU 11 identifies on the basis of the status signal which is being supplied to it via the line IRQL that a new value has been written to one or more of the result registers, it interrupts, at the next opportunity, the running of the program which is currently run by it, and runs an interrupt service routine. This interrupt service routine checks each result register in turn to determine whether new data items have been stored in the result registers 121 to 123, and reads the data items which have been stored in the result registers if they comprise new data items. The check is carried out by evaluation of the contents of the valid bids V for the respective result registers 121 to 123. When data items have been read from a result register, the CPU 11 resets the valid bit contained in this result register.

Because of the fact that the interrupt service routine checks during each call to each of all of the result registers 121 to 123 whether these registers contain new data items, and in each case reads all of the new data items, the status signal which is transmitted from the analog/digital converter 12 to the CPU 11 may be the result of an OR logic operation on the valid bits V from the result registers 121 to 123, and this signal can be transmitted via a single line IRQL to the CPU 11. The OR logic operation is carried out by means of an OR gate 124 which is provided in the analog/digital converter 12.

When a status signal that has been formed in this way occurs, the CPU 11 checks, preferably by means of an edge detector, whether new data items have been written to one or more of the result registers 121 to 123. This means that the CPU 11 uses the change in the level of the status signal from the low level to the high level (or vice versa) to identify the fact that new data items have been written to one or more of the result registers 121 to 123.

However, errors can occur in certain circumstances in this case. This is the situation, for example, when new data items are written to one result register while another result register is being read. The processes that take place in this case will be explained briefly in the following text with reference to an example.

Let us assume that the interrupt service routine is currently being run and is sequentially checking each result register to determine whether new data items have been stored in the result registers 121 to 123, and that the data items which are stored in the result registers are read if they are new data items. Let us also assume that the second result register 122 and the third result register 123 contain new data items which have not yet been read. Furthermore, let us assume that the interrupt service routine carries out the actions to be carried out by it firstly for the first result register 121, then for the second result register 122 and finally for the third result register 123.

The interrupt service routine accordingly carries out the following steps, in this sequence:
S1) Reading and evaluation of the valid bit V for the first result register 121; confirmation that the data items which are stored in the first result register 121 do not need to be read,
S2) reading and evaluation of the valid bit V for the second result register 122; confirmation that the data items which are stored in the second result register 122 must be read,
S3) reading of the data items which are stored in the second result register 122,
S4) resetting of the valid bit V for the second result register 122,
S5) reading and evaluation of the valid bit V for the third result register 123; confirmation that the data items which are stored in the third result register 123 must be read,
S6) reading of the data items which are stored in the third result register 123,
S7) resetting of the valid bit V for the third result register 123, and
S8) ending of the interrupt service routine.

Since steps S1 to S8 are carried out very quickly, all of the valid bits are normally reset when step S7 is carried out and, in consequence, the status signal which is transmitted to the CPU 11 via the line IRQL is also reset. If one of the result registers 121 to 123 is written to after this and the associated valid bit V is set, the status signal which is transmitted to the CPU 11 is also set. The edge which occurs in consequence in the status signal is identified by the CPU 11, which causes the interrupt service routine to be run once again.

On the other hand, however, it is also possible for the situation to occur in which new data items are written to a result register for which the interrupt service routine has already carried out the actions to be carried out by it, and the associated valid bit is set, while the interrupt service routine is running, that is to say for example, new data items are written to the result register 121 and the valid bit for the result register 121 is set while step S6 is still being carried out. This would result in the valid bits not all being reset after carrying out step S7, and, in consequence, the status signal which is transmitted to the CPU 11 via the line IRQL also not being reset. Since the process of writing to the result register 121 also does not result in an edge occurring in the status signal which is transmitted to the CPU 11 (at this time, the status signal had not yet been set because the valid bit for the result register 123 had not yet been reset), the CPU 11 (which reacts only to edges in the status signal) cannot know that new data items have already been written to a result register once again. In consequence, the interrupt service routine is not run again. However, the status signal cannot be reset without the interrupt service routine being run again; the status signal is reset only when all of the valid bits are reset, and the valid bits can be reset only by the interrupt service routine. In consequence, the interrupt service routine will no longer be run until the microcontroller has been switched off and on again or reset, and the data items which have been written to the result registers 121 to 123 will no longer be read.

Another possible way to signal to the CPU 11 that data items have been written to one of the result registers 121 to 123 in the analog/digital converter is to transmit a short pulse to the CPU 11 via the line IRQL whenever new data items are written to one of the result registers 121 to 123. With a procedure such as this, the problems mentioned above cannot occur. However, the status signal pulses which are transmitted via the line IRQL are reliably detected in the CPU 11 only by an edge detector. In particular, it is not possible, or is not in every case reliably possible, to detect the status signal pulses by checking the status signal level (polling) at predetermined time intervals. In order to ensure reliable detection of the status signal pulses, it will be necessary to ensure that a time which is greater than the predetermined time between two successive polling times elapses between two successive status signal edges. However, since the result registers 121 to 123 can be written to and read from at any given times, it is not possible to ensure that this condition will be satisfied in all circumstances. A further exacerbating factor is that the clock signal with which the CPU 11 operates and the clock signal with which the analog/digital converter 12 operates may be different clock signals, which may differ not only in frequency but also in phase. The lack of capability to detect the status signal pulses by means of polling would not be disadvantageous in the example under consideration because the CPU 11 in fact uses an edge detector to determine the edges contained in the status signal. However, it should be evident and requires no further explanation that it would be advantageous for the status signal which is emitted from the analog/digital converter to be produced in such a way that it can be identified and evaluated not only by means of an edge detector but also by polling. An analog/digital converter such as this could be used without any modifications to it even in microcontrollers whose CPU 11 detects the status signal profile by polling.

Furthermore, it would also be possible to use an analog/digital converter such as this in systems in which the status signal which is emitted from the analog/digital converter is supplied at the same time to a plurality of system components which detect the status signal profile in different ways.

The problems described above occur not only in the case of cooperation of an analog/digital converter and a CPU but in any electrical circuit in which a first component in the electrical circuit is signaled from a second component in the electrical circuit by the transmission of a status signal to the effect that a state or an event which requires a reaction from the first component has occurred in the second component. In this case, furthermore, the state or event to be signaled need not relate to writing to a result register or some other memory; the state to be signaled or the event to be signaled may be any desired state or any desired event.

### SUMMARY

An object of the invention is to improve the reliability on detecting states or events within the electrical circuit signaled by means of the status signal.

In a form of the present invention it is distinguished in that after each resetting of the first data items or of the second data items, a different signal than the status signal which is transmitted to the first component is used for a predetermined time instead of the result of the logic operation.

If the “other” signal is a signal which is used to signal to the first component that no state or event which requires a reaction from the first component has occurred in the second component, then the first component can reliably identify in all circumstances by evaluation of the status signal whether a state or an event which requires a reaction from the first component has occurred in the second component. Furthermore, the first component can also detect and evaluate a status signal such as this by checking (polling) the status signal level at predetermined time intervals.

### BRIEF DESCRIPTION OF THE DRAWINGS

Other features and advantages of the invention will become apparent by reference to the following detailed description when considered in conjunction with the accompanying drawings, in which:

FIG. 1 shows the design of the microcontroller described above,

FIG. 2 shows the design of an analog/digital converter which produces a status signal whose time profile differs from the time profile of the status signals described above, and

FIG. 3 shows the time profile of the status signal which is produced by the analog/digital converter shown in FIG. 2.

### DETAILED DESCRIPTION

The method described in the following text is a method by means of which a first component of an electrical circuit is signaled from a second component of the electrical circuit by the transmission of a status signal to the effect that a state or an event which requires a reaction by the first component has occurred in the second component,
with first data items being stored in the second component which can be set to a specific value by the second component and can be reset by the first component when a first state or event occurs which requires a reaction from the first component,
with second data items being stored in the second component which can be set to a specific value by the second component and can be reset by the first component when a second state or event occurs which requires a reaction from the first component, and
with the first data items and the second data items being subjected to a logic operation, and with the result of the logic operation being used as the status signal which is transmitted to the first component.

In the example under consideration, the electrical circuit is a microcontroller, the first component is the CPU of the microcontroller, and the second component is an analog/digital converter in the microcontroller.

At this point, it should be noted that this does not result in any restriction. The electrical circuit may also be any other desired electrical circuit. Furthermore, there is also no restriction for the first component to be a CPU and the second component to be an analog/digital converter. These may be any other desired components of the electrical circuit. Furthermore, there is no restriction to the states or events whose occurrence is signaled by the second circuit component to the first circuit component by means of the status signal. They may be any desired states or events. In addition, the reaction of the first circuit component to the occurrence of a state or event that is signaled to it is not subject to any restrictions. These may be any desired reactions, implemented in software and/or hardware.

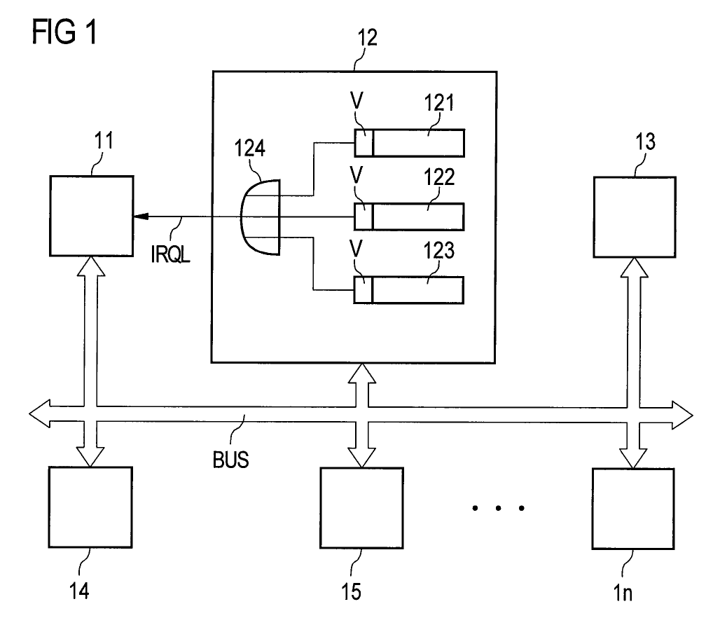

The microcontroller under consideration here has the same basic design as the microcontroller shown in FIG. 1 and described above with reference to this. However, the design of the analog/digital converter is different. The analog/digital converter that is used here produces a status signal whose time profile differs from the time profile of the status signal which the analog/digital converter 12 in the microcontroller as shown in FIG. 1 produces.

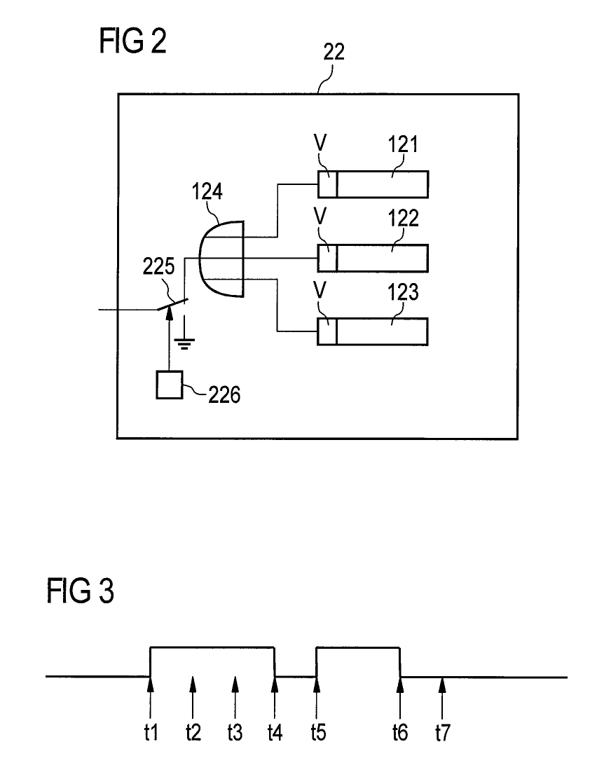

The analog/digital converter that is used is illustrated in FIG. 2. For the sake of completeness, it should be noted that only those components of the analog/digital converter which are of particular interest in the present case are illustrated and described. The analog/digital converter illustrated in FIG. 2 is annotated with the reference symbol 22, and the majority of it corresponds to the analog/digital converter 12 in the microcontroller shown in FIG. 1. The same reference symbols denote identical or mutually corresponding components.

As can be seen from FIG. 2, the analog/digital converter 22 contains result registers 121, 122 and 123, an OR gate 124, a switching device 225 and a control device 226.

The result registers 121 to 123 match, both in terms of design and function, the result registers 121 to 123 in the analog/digital converter 12 in the microcontroller as shown in FIG. 1. Once again, each result register also contains a valid bit V, which is set when new data items are written to the result register which contains the valid bit V by the analog/digital converter 22, and can be reset by the CPU 11.

The OR gate 124 matches, both with respect to design and function, the OR gate 124 in the analog/digital converter 12 in the microcontroller as shown in FIG. 1, as well. The OR gate 124 is used to subject the valid bits V of all (or possibly also only of specific) result registers to an OR logic operation. However, the result of the OR logic operation is used only at times as the status signal which is transmitted to the CPU via the line IRQL.

The output signal from the OR gate 124 is supplied to a first input connection of the switching device 225. In addition, the switching device 225 also has a second input connection and an output connection. The second input connection of the switching device 225 has a voltage applied to it which corresponds to the voltage which the OR gate 124 emits when no state or event which requires a reaction from the CPU has occurred in the analog/digital converter 22, that is to say when all of the valid bits have been reset. In the example under consideration, the second input connection of the switching device 225 is connected to ground. The output connection of the switching device 225 is connected to the line IRQL via which the status signal is transmitted to the CPU. In contrast to the analog/digital converter 12 in the microcontroller shown in FIG. 1, the output signal from the switching device 225 is used, rather than the output signal from the OR gate 124, as the status signal to be transmitted to the CPU.

The switching device 225 is controlled by the control device 226. The control device 226 drives the switching device 225 in such a way that it emits the voltage (ground potential) that is applied to the second input connection for a predetermined time (for example for a number of clock cycles) after each resetting of one of the valid bits V, and in such a way that it emits the signal (the output signal from the OR gate 124) which is supplied to the first input connection at all other times.

The time during which the switching device 225 emits the voltage which is supplied to it via the second input connection is of such a duration that the CPU can reliably detect the edge in the status signal which can occur when the switching device 225 once again emits the signal which is supplied to it via its first input connection. The time during which the switching device 225 emits the voltage which is supplied to it via the second input connection in consequence depends on the clock rates at which the CPU and the analog/digital converter operate (these are not necessarily the same clock rates), and on the electrical characteristics of the line IRQL. This time can be defined by hardware, or can be varied or adjusted by the user of the microcontroller (for example by appropriately writing to a control register which is contained in the analog/digital converter).

FIG. 3 shows the time profile of the status signal which is transmitted via the line IRQL. The illustration of the status signal profile is only a schematic representation in order to explain the special features of the status signal profile. This illustration is not to scale; in particular, the time is not shown to scale.

The status signal profile illustrated in FIG. 3 was based on:
the valid bit being at the level 0 when the result register which contains the valid bit does not contain any new (not yet retrieved) data items,
the valid bit is set to the value 1 by the analog/digital converter 22 whenever new data items are written to the result register which contains the valid bit, and
the valid bit is reset to the level 0 by the CPU whenever the result register which contains the valid bit has been read.

For the sake of completeness, it should be noted at this point that this situation could be precisely reversed, that is to say:
the valid bit is at the level 1 when the result register which contains the valid bit does not contain any new (not yet retrieved) date items;
the valid bit is set to the value 0 by the analog/digital converter 22 whenever new data items are written to the result register which contains the valid bit, and
the valid bit is reset to the level 1 by the CPU whenever the result register which contains the valid bit has been read.

In the last-mentioned case, the second input connection of the switching device 225 would have to have a voltage which represents the level 1 applied to it. In addition, the OR gate 124 would have to be replaced by an AND gate.

The time profile of the status signal as shown in FIG. 3 is initially based on the assumption that all valid bits are at the level 0, and that a relatively long time has already elapsed since reading one of the result registers in the analog/digital converter 22. In consequence, the output signal from the OR gate 124 is at the level 0, and the output signal from the OR gate 124 is emitted through the switching device 225 to the line IRQL.

Let us assume that new data items are written to the result register 122 at a time t1. The level of the valid bit in the result register 122 therefore changes from 0 to 1 at the time t1, or shortly after it. As a consequence of this, the output signal from the OR gate 124 also jumps from the level 0 to the level 1, as does the status signal which is transmitted via the line IRQL. Shortly after this, to be more precise at a time t2, new data items may also be written to the result register 123, and the valid bit in the result register 123 can be set to the level 1. However, this has no influence on the status signal since, in fact, this was already at the level 1. The edge which occurs in the status signal at the time t1 is identified by the CPU, to be more precise by the edge detector that is contained in it, and this results in the associated interrupt service routine being started. Let us assume that the interrupt service routine is started at the time t3. The interrupt service routine first of all reads the valid bit from the result register 121 in order to confirm whether new (no yet read) data items are stored in the result register 121. Since the valid bit in the result register 121 is at the level 0, the CPU confirms that this is not the case, and does not read the data items which are stored in the result register 121. The interrupt service routine then reads the valid bit from the result register 122, in order to confirm whether new (not yet read) data items are stored in the result register 122. Since the valid bit in the result register 122 is at the level 1, the CPU confirms that this is the case, and reads the data items which have stored in the result register 122. Then (or at the same time), the CPU resets the valid bit in the result register 122 to the level 0. Let us assume that the valid bit is reset at the time t4. The resetting of the valid bit by the control device 226 results in the switching device 225 being driven such that it emits the signal which is supplied to it via the second input connection. The status signal which is transmitted via the line IRQL thus jumps to the level 0 at the time t4. The switching device 225 is kept in this state for only a relatively short time, for example a few clock cycles.

After this, to be more precise at a time t5, it is driven by the control device 226 once again such that it emits the signal which is supplied to it via the first input connection, that is to say the output signal from the OR gate 124. Since the result register 123 has not yet been read, and its valid bit has not yet been reset, at this time, the output signal from OR gate 124 is still at the level 1, so that the signal which is emitted from the switching device 225 jumps to the level 1 again at the time t5. In parallel with this, the interrupt service routine is run again. After the time t4, the interrupt service routine reads the valid bit from the result register 123 in order to confirm whether new (not yet read) data items are stored in the result register 123. Since the valid bit in the result register 123 is at the level 1, the CPU confirms that this is the case, and reads the data items which are stored in the result register 123. Then (or at the same time), the CPU resets the valid bit in the result register 123 to the level 0. Let us assume that the valid bit is reset at the time t6. The resetting of the valid bit results in the switching driving 225 being driven by the control device 226 such that it emits the signal which is supplied to it via the second input connection. This status signal which is transmitted via the line IRQL thus jumps to the level 0 at the time t6. The switching device 225 is kept in this state for only a relatively short time, for example for a few clock cycles. After this, to be more precise at the time t7, it is driven by the control device 226 again such that it emits the signal which is supplied to it via the first input connection, that is to say the output signal from the OR gate 124. Since all of the result registers have been read and their valid bits have been reset at this time, the output signal from the OR gate 124 is now at the level 0, so that the signal which is emitted from the switching device 225 is once again at the level 0. The interrupt service routine is ended immediately after the time t6.

In the case of the analog/digital converter 12 described initially, problems occurred when new data items were written to the result register for which the interrupt service routine had already carried out the actions to be carried out by it, and the associated valid bit had been set, while running the interrupt service routine, that is to say, for example, new data items had been written to the result register 121, and the valid bit in the result register 121 had been set, between the times t4 and t6. This does not result in any problems in the case of the analog/digital converter 22 because, in a situation such as this, the OR gate 124 would still emit a signal at the level 1 after the time t6, and the status signal would jump to the level 1 at the time t7. The status signal edge resulting from this would be identified by the CPU, and would result in the interrupt service routine being run again.

A status signal which is produced and has the profile as described above could also be used as a status signal for a CPU (or for any other desired device within or outside the microcontroller) which detects the status signal by checking (polling) the status signal level at predetermined time intervals. This is because the phases of the status signal in which this signal is at the level 1 automatically last at least until the CPU has identified that a status signal at the level 1 is being supplied to it. The status signal cannot jump back to the level 0 until all of the valid bits have been reset. However, the valid bits can be reset only by means of a service routine which corresponds to the interrupt service routine mentioned above, although this service routine is carried out only once the CPU has identified that it is being supplied with a status signal at the level 1. The fact that the status signal briefly jumps to the level 0 after each occasion on which a valid bit is reset does not preclude the reliable identification of the situation in which a state which requires a reaction from the CPU or an event which requires a reaction from the CPU has occurred in the analog/digital converter, because the status signal in fact jumps to the level 0 only briefly so that, in the worst case, it is possible for there to be a slight delay in identification of the situation in which a state which requires a reaction from the CPU or an event which requires a reaction from the CPU has occurred in the analog/digital converter. This is true irrespective of the time intervals at which the CPU checks the status signal.

It may also be found to be advantageous, at least in certain circumstances, for the interrupt service routine or the service routine to use only the valid bits to check whether new data items have been written to the result registers, and to reset the valid bits that have been set without reading the new data items which have been stored in the result registers. The data items can then be read at any desired later time; the CPU knows the result registers in which new data items have been stored by reading and evaluation of the valid bits.

The method described above can be modified in many ways. For example, there is no restriction to the valid bits being logically linked by means of an OR gate. In certain applications, it may be found to be advantageous for the valid bits to be subjected to a different logic operation, for example to an AND operation, that is to say for the OR gate 124 to be replaced by an AND gate or some other logic gate. Furthermore, it is not absolutely essential for the interrupt service routine or the service routine to carry out the actions described above. For example, it would be possible to provide for the interrupt service routine or the service routine to be ended once it has read the stored data items from the first result register in which new data items have been stored, and has reset the valid bit. For example, it could also be possible to provide for the interrupt service routine or the service routine to check the level of the output signal from the OR gate 124 after each occasion on which a valid bit is reset, and for the interrupt service routine or the service routine then to continue to be run until the output signal from the OR gate 124 is at the level 0, and/or the interrupt service routine or the service routine to be run only until the output signal from the OR gate 124 is at the level 0.

Irrespective of the details of the practical implementation, the described method makes it possible for any desired first component in an electrical circuit to reliably detect the states or events in the second component which are to be signaled to it by the status signal, in all circumstances, irrespective of the way in which it detects the level or the profile of the status signal which is supplied to it from a second component in the electrical circuit.

### LIST OF REFERENCE SYMBOLS

11 CPU
12 Analog/digital converter
13 Microcontroller component
14 Microcontroller component
15 Microcontroller component
1n Microcontroller component
122 Analog/digital converter
121 Result register
122 Result register
123 Result register
124 OR gate
225 Switching device
226 Control device
BUS Bus
IRQL Single line
V Valid bit

What is claimed is:

1. A method by means of which a first component of an electrical circuit is signaled from a second component of the electrical circuit by the transmission of a status signal to the effect that a state or an event which requires a reaction by the first component has occurred in the second component, the method comprising the steps of:
storing first data items in the second component which can be set to a specific value by the second component and can be reset by the first component when a first state or event occurs which requires a reaction from the first component,
storing second data items in the second component which can be set to a specific value by the second component and can be reset by the first component when a second state or event occurs which requires a reaction from the first component,
subjecting the first data items and the second data items to a logic operation, and using the result of the logic operation as the status signal which is transmitted to the first component, and
after each resetting of the first data items or of the second data items, using for a predetermined time instead of the result of the logic operation a different signal as status signal which is transmitted to the first component.

2. A method according to claim 1, wherein the status signal which is transmitted to the first component for a predetermined time instead of the result of the logic operation after each resetting of the first data items or of the second date items is a signal which signals to the first component that no state or event which requires a reaction from the first component has occurred in the second component.

3. A method according to claim 1, wherein when the first component is supplied with a status signal from the second component, signaling to it that a state or event which requires a reaction from the first component has occurred in the second component, the first component reads the first data items and the second data items in order to determine how the first component must react.

4. A method according to claim 1, wherein the first component resets the first data items once it has carried out the actions which it has to carry out on the occurrence of the first state or event.

5. A method according to claim 1, wherein the first component resets the first data items before it has carried out the actions which it has to carry out on the occurrence of the first state or event.

6. A method according to claim 5, wherein the first component resets the first data items once it has determined by reading the first data items that it must carry out the actions which must be carried out on the occurrence of the first state or event.

7. A method according to claim 1, wherein the first component resets the second data items once it has carried out the actions which it has to carry out on the occurrence of the second state or event.

8. A method according to claim 1, wherein the first component resets the second data items before it has carried out the actions which it has to carry out on the occurrence of the second state or event.

9. A method according to claim 8, wherein the first component resets the second data items once it has determined by reading the second data items that it must carry out the actions to be carried out on the occurrence of the second state or event.

10. A method according to claim 1, wherein the first data items and the second data items are subjected to an OR logic operation, and the result of the OR logic operation is used as the status signal which is transmitted to the first component.

11. A method according to claim 1, wherein the first data items and the second data items are subjected to an AND logic operation, and the result of the AND logic operation is used as the status signal which is transmitted to the first component.

12. A method according to claim 1, wherein the status signal which is transmitted from the second component to the first component is transmitted via a single line to the first component.

13. A method according to claim 1, wherein the first component is a component which runs a software program, and when the status signal signals to the first component that a state or event which requires a reaction from the first component has occurred in the second component, the first component, as a reaction to this, interrupts the program which it is currently running and runs an interrupt service routine or a service routine.

14. A method according to claim 1, wherein the predetermined time for which a different signal from the status signal which is transmitted to the first component is used instead of the result of the logic operation after each resetting of the first data items or of the second data items is permanently set in the second component.

15. A method according to claim 1, wherein the predetermined time for which a different signal from the status signal which is transmitted to the first component is used instead of the result of the logic operation after each resetting of the first data items or of the second data items is a time which can be set or varied by the user of the second component.

16. An electrical circuit comprising a first component and a second component, wherein the second component is operable to signal the first component by the transmission of a status signal that a state or an event has occurred in the second component, further comprising:
first data items being stored in the second component which can be set to a specific value by the second component and can be reset by the first component when a first state or event occurs,
second data items being stored in the second component which can be set to a specific value by the second component and can be reset by the first component when a second state or event occurs,
wherein the first data items and the second data items are subjected to a logic operation, and the result of the logic operation is used as the status signal which is transmitted to the first component, and
wherein after a resetting of the first data items or of the second data items, for a predetermined time period instead of the result of the logic operation a different signal is used as status signal which is transmitted to the first component.

17. The circuit according to claim 16, wherein the status signal which is transmitted to the first component for a predetermined time instead of the result of the logic operation after a resetting of the first data items or of the second date items is a signal which signals to the first component that no state or event has occurred in the second component.

18. A microcontroller comprising:
a central processing unit coupled with a component wherein the component is operable to transmit a status signal to the central processing unit when a state or an event which requires a reaction by the central processing unit has occurred in the component,
first data items stored in the component operable to be set to a specific value by the component and operable to be reset by the central processing unit when a first state or event occurs which requires a reaction from the central processing unit,
second data items stored in the component operable to be set to a specific value by the component and operable to be reset by the central processing unit when a second state or event occurs which requires a reaction from the central processing unit,
a logic operator for subjecting the first data items and the second data items to a logic operation, wherein the result of the logic operation is used as the status signal which is transmitted to the central processing unit, and wherein
the central processing unit is operable after each resetting of the first data items or of the second data items, to receive for a predetermined time instead of the result of the logic operation a different signal as status signal which is transmitted to the central processing unit.

19. A microcontroller according to claim 18, wherein the status signal which is transmitted to the central processing unit for a predetermined time instead of the result of the logic operation after each resetting of the first data items or of the second date items is a signal which signals to the central processing unit that no state or event which requires a reaction from the central processing unit has occurred in the component.

20. A microcontroller according to claim 18, wherein when the central processing unit is supplied with a status signal from the component, signaling to it that a state or event which requires a reaction from the central processing unit has occurred in the component, the central processing unit is operable to read the first data items and the second data items in order to determine how the central processing unit must react.
